(19) United States
(12) Patent Application Publication
(10) Pub. No.: US 2005/0158039 A1
(43) Pub. Date: Jul. 21, 2005

(54) Digital camcorder

(75) Inventors: Jung-Min Han, Seoul (KR); Mi-Sun Kim, Seoul (KR); Yong-Il An, Goyang-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/034,930

(22) Filed: Jan. 14, 2005

(30) Foreign Application Priority Data
Jan. 16, 2004 (KR) 2004-3268

(51) Int. Cl. H04N 5/76; H04N 5/225

(52) U.S. Cl. 386/117; 386/118

(57) ABSTRACT

A compact and light digital camcorder is disclosed. The digital camcorder comprises a camcorder body, a camera unit movably postionable with respect to the camcorder body in a longitudinal direction, and a storage medium mouting part, and a battery mounting part mounted on the camcorder body. The camera unit is substantially received within the camcorder body when not in use, and substantially protrudes from the camcorder body by pressing a top of the camcorder body for use.

### CROSS-REFERENCE TO RELATED APPLICATIONS

This application claims the benefit under 35 U.S.C. § 119(a) of Korean Patent Application No. 2004-3268, entitled “Digital Camcorder,” filed Jan. 16, 2004, the entire contents of which are hereby incorporated herein by reference.

### BACKGROUND OF THE INVENTION

1. Field of the Invention

The present invention relates to a camcorder. More particularly, the present invention relates to a portable camcorder which minimizes size and weight for portability.

2. Description of the Related Art

Generally, camcorders convert a moving image to an electrical signal. The electrical signal is recorded onto a predetermined storage medium. Recently, the size and weight of camcorders is being minimized as digital storage media is developing. Consequently, the use of recording mediums having magnetic tape, which are bulky, is gradually decreasing.

Since the introduction of flash memory, a digital storage media, the size of image photographing apparatuses such as the camcorder have been drastically reduced. Flash memory consumes minimal amounts of electric power and is able to preserve stored information even though the power supply is switched off. Flash memory is divided into NAND flash memory for storing a large amount of data and a NOR flash memory for rapid processing. NAND flash memory enables high integration, and therefore, it is generally used to store sound and image data.

A variety of camcorders utilizing the aforementioned digital storage medium have been developed. The size and weight of a camcorder operates as a significant factor for purchase by users, and accordingly, reduction of size and weight is important.

Accordingly, there is a continual need for smaller and lighter camcorders.

### SUMMARY OF THE INVENTION

Accordingly, embodiments of the present invention provide a camcorder, using a digital storage medium, for storing still and movable images that is smaller in size and lighter in weight.

The foregoing and other objects and advantages are substantially realized by providing a digital camcorder comprising a camcorder body, a camera unit movably positionable with respect to the camcorder body in a longitudinal direction, and a storage medium mounting part and a battery mounting part on the camcorder body. The camera unit is substantially received in the camcorder body when not in use, and substantially protrudes from the camcorder body by pressing a top of the camcorder body for use.

The camcorder body comprises a mode switch rotatably mounted to the camcorder body.

The mode switch rotates about a longitudinal central axis of the camcorder body to output different mode selection signals according to a predetermined rotational angle, respectively.

The camcorder body includes a lower cap that is removable for exposing the storage medium mounting part and the battery mounting part.

The camera unit comprises a lens part for capturing an external image, and an image projection part disposed behind the lens part to display the captured image.

Other objects, advantages, and salient features of the invention will become apparent to those skilled in the art from the following detailed description, which, taken in conjunction with the annexed drawings, discloses preferred embodiments of the invention.

### BRIEF DESCRIPTION OF THE DRAWING FIGURES

The above and other objects, features, and advantages of the present invention will become more apparent from the following description taken in conjunction with the accompanying drawings, in which;

FIG. 1A is a perspective view of a camcorder in accordance with an embodiment of the present invention, with a lens part thereof exposed out of the camcorder body;

FIG 1B is an exploded and perspective view showing the camcorder of FIG. 1, with a lower cap;

FIG. 2 is a perspective view of the camcorder show in FIG. 1 with an image projection part thereof exposed out of the camcorder body;

FIG. 3 is a front view showing the camcorder of FIG. 1, with a camera unit moving between first and second positions; and

FIG. 4 is a perspective view showing the operation of a mode switch of the camcorder of FIG. 1.

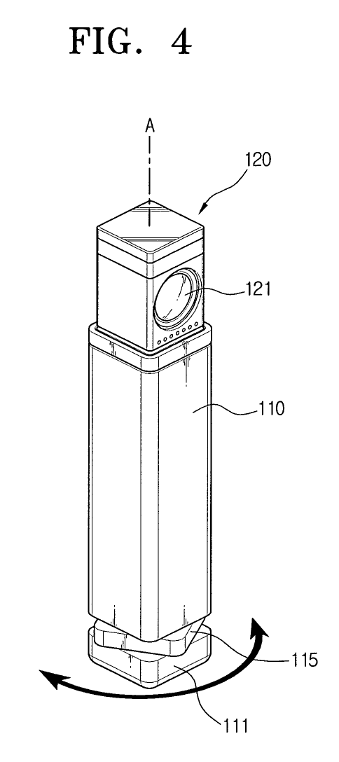

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications to the embodiments described herein can be made without departing from the scope and spirit of the invention. Also, descriptions of well-known functions and constructions are omitted for conciseness.

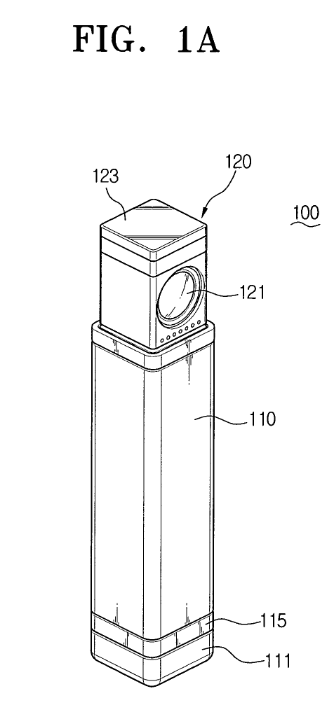

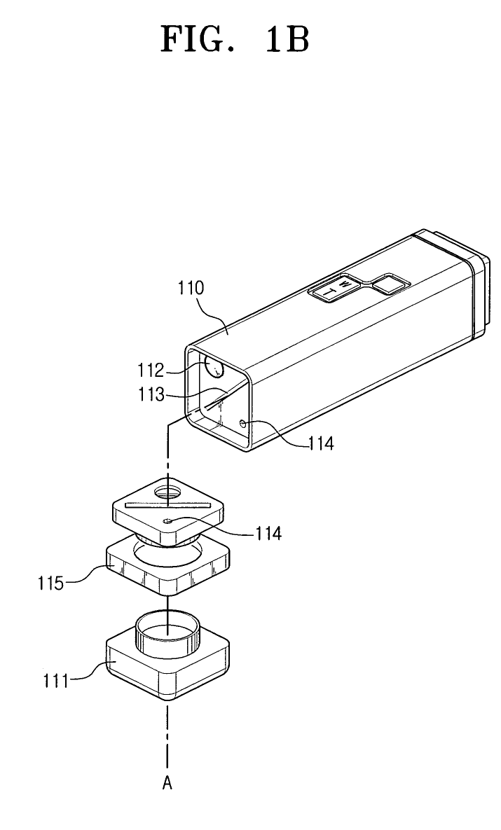

Referring to FIG. 1A, a digital camcorder 100 according to an aspect of the present invention is illustrated. The digital camcorder 100 comprises a camcorder body 110 and a camera unit 120 movably positioned in and out of the camcorder body 110.

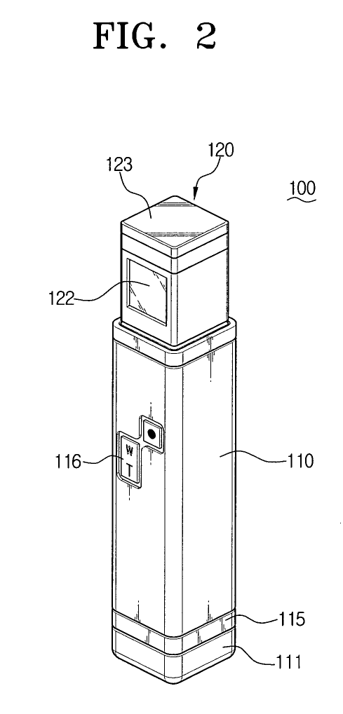

As shown in FIG. 1A, the camcorder body 110 is preferably formed as a column shape and is preferably about the size of a conventional lipstick container. As shown in FIG. 1B, camcorder body 110 comprises a removable lower cap 111 disposed on a bottom surface thereof. Additionally, as shown in FIG. 2, an operation switch 116 is provided on a rear surface of the camcorder body 110 to control a record function and a zoom function.

Lower cap 111 fits into a groove formed on the camcorder body 110. A mode switch 115 is rotatably mounted between the camcorder body 110 and the lower cap 111, as shown in FIG. 1B. The mode switch 115 rotates about a longitudinal central axis ‘A’ of the camcorder body 110 for outputting different mode selection signals according to a rotational angle of the mode switch 115.

When the lower cap 111 is removed, a storage medium mounting part 112, a battery mounting part 113 and a terminal part 114 formed proximate a bottom surface of the camcorder body 110 are exposed. The storage medium mounting part 112 is formed as a slot for receiving a memory stick or a flash memory in a longitudinal direction. The battery mounting part 113 is configured as a groove for mounting a charging battery or a mercury battery. Terminal parts 114 are provided for both the camcorder body 110 and the lower cap 111, respectively, and correspond to each other. Terminal part 114 transmits an operation signal of the mode switch 115 toward the camcorder body 110.

As shown in FIGS. 1-2, camera unit 120 comprises lens part 121 for capturing an external image. An image projection part 122 is disposed behind the lens part 121 to display the captured image. Preferably, a liquid crystal display (LCD) is employed as the image projection part 122.

When not in use, the camera unit 120 is received in the camcorder body 110 for protecting the lens part 121 and the image projection part 122 from physical damage. In use, the camera unit 120 protrudes from the camcorder body 110 so that lens part 121 is protrudes out of the camcorder body 110.

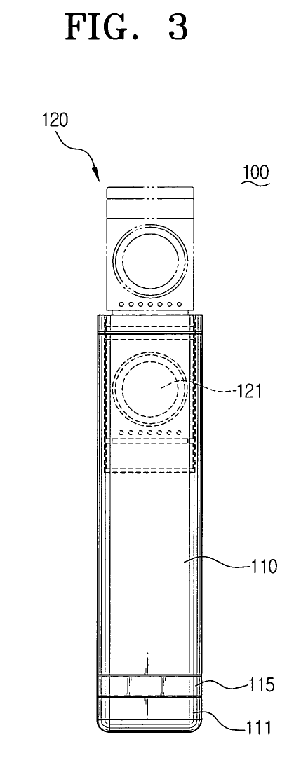

When a top 123 of the camera unit 120 is pressed, the camera unit 120 extends from the camcorder body 110, as shown in FIG. 3.

According to the above-structured digital camcorder 100, the lens part 121 and the image projection part 122 of the camera unit 120 are protected from physical damage such as scratching since the camera unit 120 is received in the camcorder body 110 when not in use. In addition, by using a digital storage medium such as the memory stick or the flash memory, storage medium space is saved, so that digital camcorder 100 is smaller and lighter for improving portability.

As can be appreciated from the above digital camcorder 100, due to its smaller size and light weight, the user can operate the digital camcorder 100 for a long time without feeling discomfort such as fatigue.

Furthermore, user convenience is enhanced since the above digital camcorder 100 can be gripped and operated with one hand, and the camera unit 120 can be withdrawn simply by using a button formed on the camcorder body 110.

While the invention has been shown and described with reference to certain embodiments thereof, it will be understood by those skilled in the art that various changes in form and details may be made therein without departing from the spirit and scope of the invention as defined by the appended claims.

1. A digital camcorder comprising:
a camcorder body;
a camera unit movably positionable with respect to the camcorder body in a longitudinal direction;
a storage medium mounting part and a battery mounting part are connected to the camcorder body, and
wherein the camera unit is substantially received within the camcorder body when not in use, and substantially protrudes from the camcorder body by pressing a top of the camcorder body for use.

2. The digital camcorder of claim 1, wherein
a mode switch is rotatably mounted on the camcorder body.

3. The digital camcorder of claim 2, wherein
the mode switch rotates about a longitudinal central axis of the camcorder body to output different mode selection signals according to a predetermined rotational angle, respectively.

4. The digital camcorder of claim 2, wherein
the camcorder body includes a lower cap, and the lower cap is removable for exposing the the storage medium mounting part, terminal parts, and the battery mounting part.

5. The digital camcorder of claim 1, wherein
the camera unit further comprises, a lens part for capturing an external image, and an image projection part disposed behind the lens part to display the captured image.

6. The digital camcorder of claim 1, wherein
a mode switch is rotatably mounted between the camcorder body and a lower cap.

7. The digital camcorder of claim 1, further comprising
a battery is adapted to be removably mounted to the battery mounting part.

8. The digital camcorder of claim 1, wherein
the battery mounting part is a groove for mounting a charging battery.

9. The digital camcorder of claim 1, wherein
the battery mounting part is a groove for mounting a mercury battery.

10. The digital camcorder of claim 1, wherein
a storage medium is removably mounted to the storage mounting part.

11. The digital camcorder of claim 1, wherein
the storage medium mounting part is formed as a slot for receiving a memory stick in a longitudinal direction.

12. The digital camcorder of claim 1, wherein
the storage medium mounting part is formed as a slot for receiving a flash memory stick in a longitudinal direction.

13. The digital camcorder of claim 1, wherein
a terminal part is provided on both the camcorder body and a lower cap for transmitting an operation signal to a mode switch.

14. The digital camcorder of claim 1, wherein
an operation switch is disposed on the camcorder body for controlling a record function and a zoom function.
